(19) United States
(12) Patent Application Publication
(10) Pub. No.: US 2015/0109247 A1
(43) Pub. Date: Apr. 23, 2015

(54) TOUCH PANEL AND MANUFACTURING METHOD THEREOF

(71) Applicant: WINTEK CORPORATION, Taichung City (TW)

(72) Inventors: Kuo-Hsing Chen, New Taipei City (TW); Chung-Hsien Li, Taichung City (TW); Yu-Ting Chen, Pingzhen City (TW); Chen-Hao Su, Taichung City (TW); Kuo-Chang Su, Taichung City (TW)

(21) Appl. No.: 14/519,214

(22) Filed: Oct. 21, 2014

(30) Foreign Application Priority Data
Oct. 21, 2013 (TW) 102137972

(51) Int. Cl. G06F 3/044

(52) U.S. Cl. CPC G06F 3/044
USPC 345/174

(57) ABSTRACT

A touch panel and a manufacturing method thereof are provided. The touch panel includes a substrate, a plurality of conductive patterns, a plurality of signal transmitting lines, a plurality of first pad portions, a plurality of second pad portions and at least one auxiliary pattern. The first pad portions are separately arranged along a first path. The second pad portions are insulated from the first pad portions. The second pad portions are separately arranged along a second path. At least one auxiliary pattern is disposed between two adjacent first pad portions, between two adjacent second pad portions, or between one of the first pad portions and one of the second pad portions which are adjacent. The insulating intervals are disposed between adjacent first pad portions and between adjacent second pad portions.

This application claims the benefit of Taiwan application Serial No. 102137972, filed Oct. 21, 2013, the subject matter of which is incorporated herein by reference.

### BACKGROUND

1. Technical Field

The disclosure relates in general to a panel and a manufacturing method thereof, and more particularly to a touch panel and a manufacturing method thereof.

2. Description of the Related Art

With the development of technology, various electronic devices are provided. Touch panels are innovative products. User can touch the touch panel to input a controlling signal, for example, writing or drawing. Especially, the touch panel can be combined with a display panel for the user to instinctively input on a display frame. It is quite convenient. Therefore, various electronic devices are equipped with the touch panel.

By bonding the touch panel to a circuit board, the touch panel can receive a signal from a controlling circuit or transmit a signal to the controlling circuit. In particular, a plurality of pads can be disposed on the touch panel and be thermocompression bonded to the circuit board. For increasing the touching resolution, narrowing the border and reducing the cost, the density of the pads is increased. It is needed to avoid the pads from electric short, electric leakage or electro static discharge (ESD).

### SUMMARY

The disclosure is directed to a touch panel having a plurality of pad portions disposed along a plurality of rows and interlaced for reducing the distribution area of the pad portions with sufficient antistatic ability. Therefore, the width of the circuit board and the cost are reduced and a touch panel having high touching resolution and narrow border can be applied. Moreover, auxiliary patterns are used for making the force applied for thermocompression bonding the touch panel and the circuit board to be easily controlled, such that the yield rate of conduction can be improved. Further, a plurality of aligning pads are used for making the touch panel and the circuit board being aligned, such that the accuracy of bonding the pad portions and the pads of the circuit board can be improved. Moreover, the present invention is further directed to a manufacturing method of the touch panel. A plurality of insulating intervals are formed by penetrating the conductive material layer. Various patterns, pad portions and transmitting lines are formed at the same time. The process for forming those elements is easy and can effectively reduce the manufacturing cost.

According to a first aspect of the present disclosure, a touch panel is provided. A touch panel includes a substrate, a plurality of conductive patterns, a plurality of signal transmitting lines, a plurality of first pad portions, a plurality of second pad portions and at least one auxiliary pattern. The conductive patterns are disposed on the substrate. The signal transmitting lines are disposed on the substrate. The first pad portions are electronically connected to part of the conductive patterns via part of the signal transmitting lines. The first pad portions are separately arranged along a first path. The second pad portions are electronically connected to another part of the conductive patterns via another part of the signal transmitting lines. The second pad portions are insulated from the first pad portions. The second pad portions are separately arranged along a second path which is not overlapped with the first path. Each second pad portion is disposed between two adjacent ones of the first pad portions. The auxiliary pattern is disposed between two adjacent ones of the first pad portions, between two adjacent ones of the second pad portions, or between all of the first pad portions and all of the second pad portions. The auxiliary pattern is insulated from the conductive patterns, the signal transmitting lines, the first pad portions and the second pad portions. A plurality of insulating intervals are located between two adjacent ones of the first pad portions, between two adjacent ones of the second pad portions, and between one of the first pad portions and one of the second pad portions which are adjacent, respectively.

According to a second aspect of the present disclosure, a touch panel is provided. The touch panel includes a substrate, a plurality of conductive patterns, a light shading layer, a plurality of signal transmitting lines, a plurality of first pad portions, a plurality of second pad portions and a plurality of aligning pads. The conductive patterns are disposed on the substrate. The light shading layer is disposed on the substrate. The signal transmitting lines are disposed on the light shading layer. The first pad portions are disposed on the light shading layer, and connected to part of the conductive patterns via part of the signal transmitting lines. The first pad portions are separately arranged along a first path. The second pad portions are disposed on the light shading layer, and connected to another part of the conductive patterns via another part of the signal transmitting lines. The second pad portions are insulated from the first pad portions. The second pad portions are separately arranged along a second path which is not overlapped with the first path. Each second pad portion is disposed between two adjacent ones of the first pad portions. The aligning pads are disposed on the light shading layer for aligning with a circuit board. The insulating intervals are located between two adjacent ones of the first pad portions, between two adjacent ones of the second pad portions, and between one of the first pad portions and one of the second pad portions which are adjacent, respectively.

According to a third aspect of the present disclosure, a manufacturing method of a touch panel is provided. The manufacturing method includes the following steps. A substrate is provided. A conductive material layer is formed on the substrate. The conductive material layer is etched to form a plurality of insulating intervals, a plurality of conductive patterns, a plurality of first pad portions, a plurality of second pad portions and at least one auxiliary pattern. The first pad portions are disposed along a first path. The second pad portions are disposed along a second path. Each second pad portion is disposed between two adjacent ones of the first pad portions. The number of the insulating intervals disposed between every two adjacent ones of the first pad portions and the number of the insulating intervals between every two adjacent ones of the second pad portions are equal to or larger than two. The at least one auxiliary pattern is disposed between two adjacent ones of the first pad portions, between two adjacent ones of the second pad portions, or between all of the first pad portions and all of the second pad portions which are adjacent. The at least one auxiliary pattern is insulated from the conductive patterns, the first pad portions and the second pad portions.

The above and other aspects of the disclosure will become better understood with regard to the following detailed description of the non-limiting embodiments. The following description is made with reference to the accompanying drawings.

### BRIEF DESCRIPTION OF THE DRAWINGS

FIG. 1 shows a touch panel according to an embodiment of the present invention.

FIG. 2A shows an enlarged view of a second pad portion and a first signal transmitting line in FIG. 1.

FIG. 2B illustrates a sectional view along a sectional line X-X′ of FIG. 2A.

FIG. 2C illustrates an enlarged view of a portion M in FIG. 2A according to an alternative embodiment.

FIG. 2D illustrates a sectional view along a sectional line X-X′ of FIG. 2A according to an alternative embodiment.

FIG. 3 shows a flowchart of a manufacturing method of the touch panel.

FIG. 4 shows a plurality of insulating intervals according to an embodiment.

FIG. 5 shows the insulating intervals according to another embodiment.

FIG. 6 shows the conductive material layer around the first pad portions and the second pad portions according to an embodiment.

FIG. 7 shows the conductive material layer around the first pad portions and the second pad portions according to another embodiment.

FIG. 8 shows the conductive material layer around the first pad portions and the second pad portions according to another embodiment.

FIG. 9 shows the conductive material layer around the first pad portions and the second pad portions according to another embodiment.

FIG. 10 shows the conductive material layer around the first pad portions and the second pad portions according to another embodiment.

FIG. 11 shows the conductive material layer around the first pad portions and the second pad portions according to another embodiment.

FIG. 12 shows the conductive material layer around the first pad portions and the second pad portions according to another embodiment.

### DETAILED DESCRIPTION

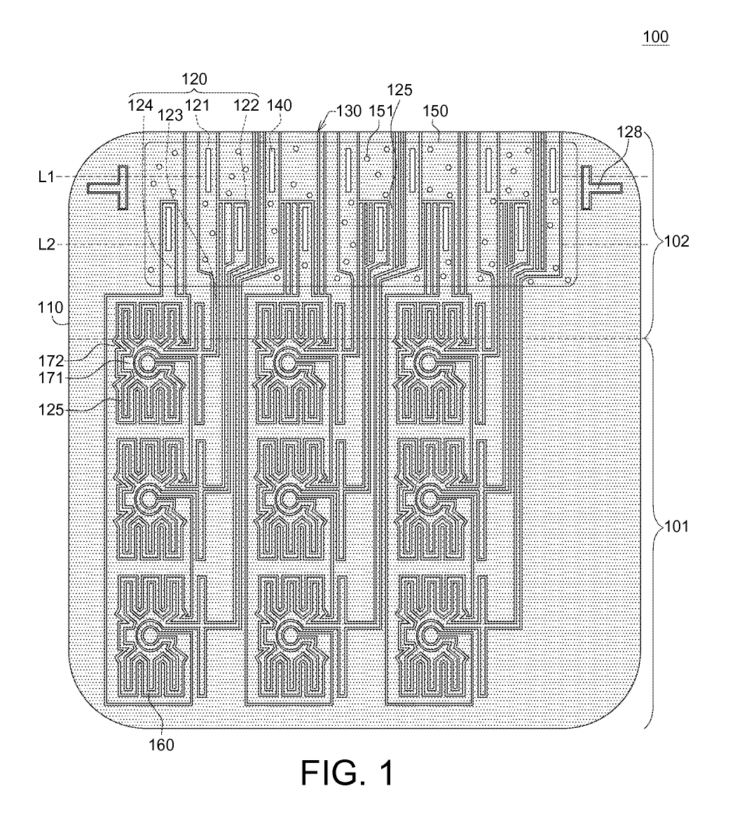

Please referring to FIG. 1, FIG. 1 shows a touch panel 100 according to an embodiment of the present invention. In the present embodiment, the touch panel 100 includes a substrate 110, a conductive material layer 120 and a plurality of pad patterns 140. The resistivity of the pad patterns 140 may less than or equal to that of the conductive material layer 120. The material of the conductive material layer 120 may be transparent material, metal, carbon nanotube, silicone or graphene. Metal may be silver nanowire, invisible copper or alloy including copper. The linewidth of the invisible metal can be neglected by eyes. For example, the linewidth may be less than 5 micrometers. The touch panel 100 has a transparent area 101 suitable for assembling with a display module, for instance, liquid crystal display or organic light emitting diode display, etc. The touch panel 100 further has a light shading area 102 adjoined to the transparent area 101. The light shading area 102 is used for shading some elements which do not want to be seen. The material of the pad patterns 140 can be a high conductivity material, such as silver paste. The pad patterns 140 are located in the light shading area 102 so as to be concealed.

The conductive material layer 120 is disposed on the substrate 110. The insulating intervals 130 divide the conductive material layer 120 to be a plurality of electric independent groups. As shown in FIG. 1, the insulating intervals 130 are strip shaped. In the transparent area 101, the width of each insulating interval 130 may be less than 50 micrometers. In some embodiments, the width of each insulating interval 130 in the transparent area 101 may be less than 30 micrometers, such that the patterns of the conductive material layer 120 are not easy to be seen. In the present embodiment, the conductive material layer 120 can be divided to a plurality of first conductive patterns 171, a plurality of second conductive patterns 172, a plurality of first pad portions 121, a plurality of second pad portions 122, a plurality of first signal transmitting lines 123, a plurality of second signal transmitting lines 124 and a plurality of auxiliary patterns 125. One end of each first signal transmitting line 123 is connected to one of the first conductive patterns 171, and another end of each first signal transmitting line 123 is connected to one of the first pad portions 121 or one of the second pad portions 122, such that a plurality of first groups are formed. One end of each second transmitting line 124 is connected to one of the second conductive patterns, and another end of each second transmitting line 124 is connected to one of the first pad portions 121 or one of the second pad portions 122, such that a plurality of second groups are formed.

The conductive material layer 120 can be made of single material, such as transparent conductive material or silver nanowire. However, the conductive material layer 120 can be made of multiple materials. For example, in the transparent area 101, the conductive material layer 120 can be made of transparent conductive material or silver nanowire whose visibility is low; in the light shading area 102, the first pad portions 121, the second pad portions 122, the first signal transmitting lines 123 and the second signal transmitting lines 124 can be made of metal whose visibility is high for reducing the signal impedance. The pad portions 140 are disposed on the first pad portions 121 and the second pad portions 122. The first pad portions 121 are separately arranged along a first path L1, and the second pad portions 122 are separately arranged along a second path L2. The second path L2 is not overlapped with the first path L1. In the present embodiment, the first pad portions 121 and the second pad portions 122 are arranged in two parallel rows. Each second pad portion 122 is disposed between two adjacent first pad portions 121, such that the first pad portions 121 and the second pad portions 122 are interlaced. In other words, an extending direction of the long axis of each second pad portion 122 is located between two adjacent first pad portions 121.

The first signal transmitting lines 123 or the second signal transmitting lines 124 can pass through the interval between two adjacent second pad portions 122, such that the first signal transmitting lines 123 and the second signal transmitting lines 124 are extended toward the same direction. The first signal transmitting lines 123 and the second signal transmitting lines 124 can be electrically connected to a controlling circuit via the first pad portions 121 and the second pad portions 122. In the present embodiment, a driving signal can be transmitted to the second conductive patterns 172 via the second signal transmitting lines 124, and the controlling circuit can receive an induced signal from the first conductive patterns 171 via the first signal transmitting lines 123. However, the present invention is not limited therein.

In the present embodiment, the insulating intervals 130 make the second conductive patterns 172 and the first conductive patterns 171 being insulated and not overlapped. The width of each insulating interval 130 between one of the second conductive patterns 172 and one of the first conductive patterns 171 which are adjacent is not larger than 30 micrometers. In particular, the second conductive patterns 172 can surround the first conductive patterns 171, and the extending direction of the first conductive pattern 171 is not intersected that of the second conductive patterns 172. According to the structure of the first conductive patterns 171 and the second conductive patterns 172, if a conductive object, such as a finger, approaches or touches the surface of the touch panel 100, a coupling capacitance will be formed between the object and first and second conductive patterns 171, 172, and the capacitive effect of the area where the object approaches or touches is changed, such that the location or movement of the object can be detected. Object can touch an exterior insulator of the touch panel 110, such as a cover lens, to perform a direct touch operation. Or, object can approach the touch panel 110 without touching, to perform a non-touch operation. Further, some well-known measuring method, such as a self capacitance measuring method or a mutual capacitance measuring method, can be applied. However, the present invention is not limited to any particular measuring method.

In the present embodiment, each auxiliary pattern 125 is disposed between one of the first groups and one of the second groups which are adjacent and insulated from the first groups and the second groups. In particular, each auxiliary pattern 125 is disposed between one of the first conductive patterns 171 and one of the second conductive patterns 172 which are adjacent, between two adjacent first pad portions 121, between two adjacent second pad portions 122, and between one of the first pad portions 121 and one of the second pad portions 122 which are adjacent. The auxiliary patterns 125, the first conductive patterns 171, the second conductive patterns 172, the first pad portions 121, the second pad portions 122, the first signal transmitting lines 123 and the second signal transmitting lines 124 are insulated from each other by the insulating intervals 130.

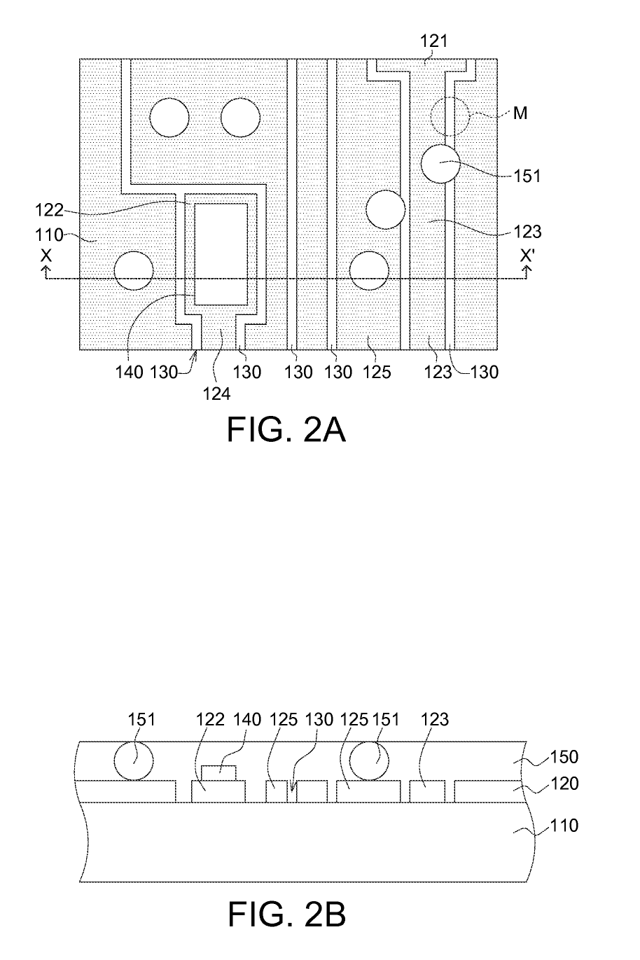

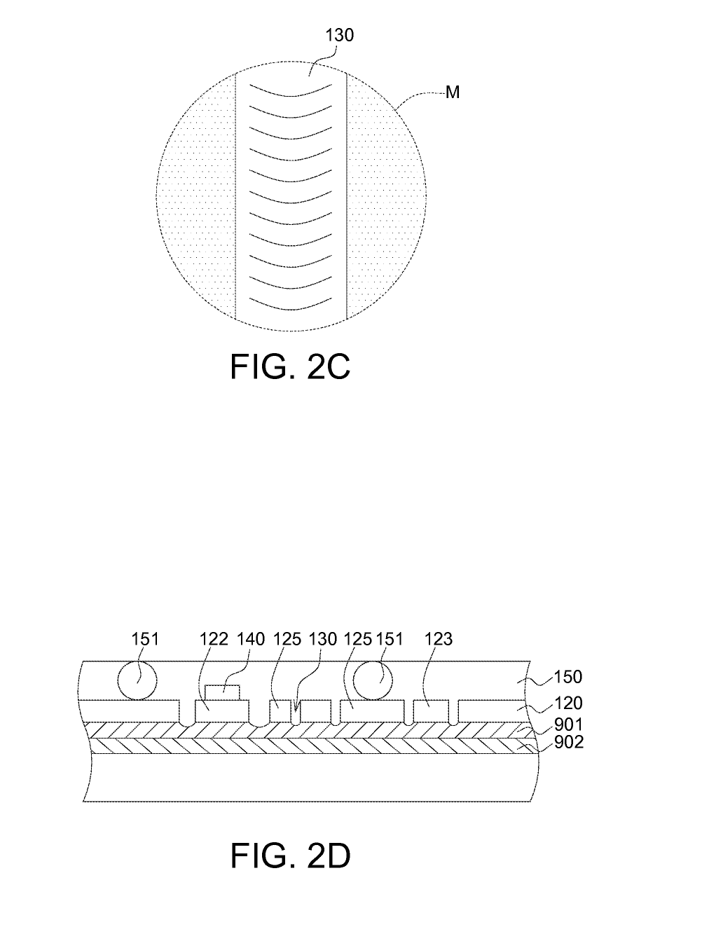

The pad portions 140 are disposed on the first pad portions 121 and the second pad portions 122. Please referring to FIGS. 2A to 2D, FIG. 2A shows an enlarged view of one second pad portion 122 and one first signal transmitting line 123 in FIG. 1, FIG. 2B illustrates a sectional view along a sectional line X-X′ of FIG. 2A, FIG. 2C illustrates an enlarged view of a portion M in FIG. 2A according to an alternative embodiment, and FIG. 2D illustrates a sectional view along a sectional line X-X′ of FIG. 2A according to an alternative embodiment. The insulating intervals 130 are disposed at the edges of the first pad portions 121, the edges of the second pad portions 122, the edges of the first signal transmitting lines 123 and the edges of the second signal transmitting lines 124. In the alternative embodiment, as shown in FIGS. 2C and 2D, a bottom surface of each insulating interval 130 has a plurality of dents. In FIG. 2D, the touch panel 100 further includes two light shading layers 901, 902, disposed on the substrate 110 and located corresponding to the light shading area 102. In the touch panel 100, the two light shading layers 901, 902 are formed first, and then the conductive material 120 is formed on the substrate 110. A laser etch process is performed to etch the conductive material 120, form the insulating intervals 130, and make the bottom surface of each insulating interval 130 have dents. In other words, part of the light shading layer 901 is etched and has uneven surface. The color of the light shading layers 901, 902 can be identical or different. Two insulating intervals 130 are located between two adjacent ones of the first pad portions 121 and two adjacent ones of the second pad portions 122, respectively. Auxiliary patterns 125 are disposed between one of the second pad portions 122 and one of the first signal transmitting lines 123. At least one auxiliary pattern 125 may be disposed between two adjacent first pad portions 121. The insulating intervals 130 may be substantially perpendicular to the first path L1 (shown in FIG. 1) and the second path L2 (shown in FIG. 1). As such, even if the pad patterns 140 spread before curing, the bonding areas can be avoided from electric short.

In one embodiment, the insulating intervals 130 not only penetrate the conductive material 120, but also penetrate the cured pad pattern 140. As such, the spread pad pattern 140 will not cause the electric short on the first pad portions 121 and the second pad portions 122.

In another embodiment, the area of each pad pattern 140 can be accurately controlled to be smaller than that of each first pad portion 121 and each second pad portion 122. Therefore, the insulating intervals 130 can be formed before forming the pad patterns 140.

It should be noted that the present invention is not limited to that the first conductive patterns 171 and the second conductive patterns 172 are designed for capacitive touch sensing. In other embodiment, a plurality of conductive patterns can be connected to a plurality of signal transmitting lines and arranged as a keyboard (for example, U.S. Pat. No. 4,954,823). That is, each conductive pattern is defined as a sensing unit, and the coordinate or the movement of the object, such as finger, is detected by a self capacitance measuring method. In another embodiment, a plurality of first conductive patterns are connected via a plurality of first connecting lines along a first direction to be a plurality of first conductive groups; a plurality of second conductive patterns are connected via a plurality of second connecting lines along a second direction to be a plurality of second conductive groups. The first connecting lines and the second connecting lines are intersected and insulated from each other. The area of the overlapping region of the first conductive groups and the second conductive groups is smaller than area of the non-overlapping region of the first conductive groups and the second conductive groups. Two ends of each first conductive group can be connected to two first signal transmitting lines which can be connected to the same pad portion or two different pad portions. Two ends of each second conductive group can be connected to two second signal transmitting lines which can be connected to the same pad portion or two different pad portions. As such, the transmitting impedance can be reduced.

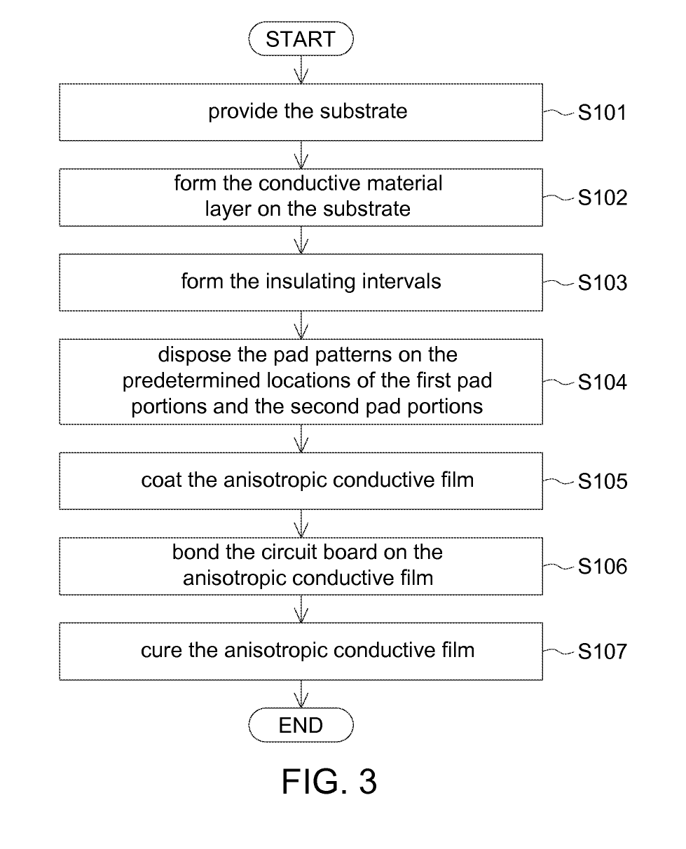

For clearly illustrating the manufacturing method of the touch panel 100, a flowchart is shown as below. Please referring to FIGS. 1 and 3, FIG. 3 shows a flowchart of the manufacturing method of the touch panel 100. Firstly, in step S101, the substrate 110 is provided. The substrate 110 can be a rigid substrate or a flexible substrate. The material of the substrate 110 can be a transparent glass or a transparent plastic.

In step S102, the conductive material layer 120 is formed on the substrate 110. The conductive material layer 120 can be formed on a predetermined region of the substrate 110 by laminating, depositing, sputtering or evaporation. When the conductive material layer 120 is made of single material, it is convenient for the manufacturing process.

In some embodiment, if light shading layers 901, 902 (shown in FIG. 2D) are disposed on a restricted area, i.e. periphery area, of the substrate 110, the substrate 110 can be acted as a covering plate of the touch panel 100 for protecting the inner elements and shading some elements which do not want to be seen. The side of the substrate 110 where the conductive material layer 120 is not disposed can be acted as an operation surface for a user. The light shading layers 901, 902 are located at the light shading area 102 of the touch panel 100. The material of the light shading layers 901, 902 can be ceramic, diamond-like carbon, ink, or photoresist with light shading property, but the present invention is not limited thereto. The light shading layers 901, 902 can be formed on the substrate 110 by screen printing or photolithography etching. Moreover, in this case, part of the conductive material layer 120 is formed on the substrate, and part of the conductive material layer 120 is formed on the light shading layer 901. The substrate 110 can be a tempered glass which is treated by a physical process or a chemical process, a laminated structure made of a poly methyl methacrylate (PMMA) layer and a polycarbonate (PC) layer, UV cured resin, such as ORGA, or other rigid transparent material. As such, the touch panel 100 can be light and thin, and the operation surface of the touch panel 100 can be planar without any light shading layer or frame. Further, anti-glare film or anti-reflective film can be disposed on the operation surface of the substrate 110 for improving the optical effect of the touch panel 100. However, in other embodiments, the light shading layers 901, 902 can be formed at the outside of the substrate 110, and a planarization layer is disposed on the substrate 110 for making the outer surface of the substrate 110 to be planar. Or, the light shading layers 901, 902 can be formed on another film and adhered to the outside of the substrate 110 by an optical adhesive

However, in some embodiments, the substrate 110 can be a color filter substrate, a flexible film substrate, a top cover plate or a bottom substrate of a display panel. A covering plate can be adhered to the substrate 110 through an adhesive. The covering plate can be adhered to one side of the substrate 110 where the conductive material layer 120 is disposed or another side of the substrate 110 where the conductive material layer 120 is not disposed, such that the covering plate can protect the substrate 110 and some elements disposed thereon. The light shading layers 901, 902 can be disposed on the covering plate instead of the substrate 110. The material of the covering plate can be a tempered glass which is treated by a physical process or a chemical process, a laminated structure made of a poly methyl methacrylate (PMMA) layer, a polycarbonate (PC) layer, UV cured resin, such as ORGA, or other rigid transparent material.

In step S103, the conductive material layer 120 is etched to form the insulating intervals 130, the first conductive patterns 171, the second conductive patterns 172, the auxiliary patterns 125, the first pad portions 121, the second pad portions 122, the first signal transmitting lines 123 and the second signal transmitting lines 124. The first pad portions 121 are arranged alone the first path L1. The second pad portions are arranged along the second path L2. Each second pad portion 122 is disposed between two adjacent first pad portions 121, such that the first pad portion 121 and the second pad portions 122 are interlaced. The conductive material layer 120 can be etched by a laser or a photolithography etching. However, the present invention is not limited thereto. When the conductive material layer 120 is etched by the laser to form the insulating intervals 130, the bottom surface of each insulating interval 130 has a plurality of dents. As shown in FIGS. 2C and 2D, the surface of the light shading layer 901 has dents corresponding to the insulating intervals 130.

In step S104, the pad patterns 140 are disposed on the first pad portions 121 and the second pad portions 122. The coverage of each pad pattern 140 can be smaller than that of each first pad portion 121 and each second pad portion 122. The resistivity of each pad pattern 140 may be less than or equal to that of the conductive material layer 120. The pad patterns 140 can be formed by printed coating or dripping. The material of the pad patterns 140 may be a high conductivity material, such as silver paste. If the light shading layers 901, 902 are disposed on the substrate 110, the first signal transmitting lines 123, the second signal transmitting lines 124, the first pad portions 121, the second pad portions 122 and the pad patterns 140 can be disposed on the light shading layers 901, 902 for being hidden.

In step S105, an anisotropic conductive film (ACF) 150 is coated on the pad patterns 140. The anisotropic conductive film 150 can be widely coated on the pad patterns 140 and the conductive material layer 120 near to the pad patterns 140. The anisotropic conductive film 150 can vertically electrically connect some elements which the anisotropic conductive film 150 are adhered via some conductive particles 151.

In step S106, a circuit board (not shown) is bonded on the anisotropic conductive film 150 for electrically connecting the circuit board and the pad patterns 140 which are disposed on the first pad portions 121 and the second pad portions 122. The circuit board can be a flexible printed circuit. The circuit board and the substrate 110 can be thermocompression bonded. Further, for accurately bonding the circuit board and the pad patterns 140, a plurality of aligning pads 128 are disposed on the substrate 110 for being aligned with a plurality of aligning symbols on the circuit board. The aligning pads 128 may be T shaped, but the present invention is not limited thereto. In the present embodiment, the aligning pads 128 are disposed at two sides of the first pad portions 121. The material of the aligning pads 128 can be metal, or the material of the aligning pads 128 can be similar to that of the conductive material layer 120. Moreover, if the light shading layers 901, 902 are disposed on the substrate 110, the aligning pads 128 can be disposed on the light shading layer 901.

In step S107, the anisotropic conductive film 150 is cured. As such, the bonding process of the circuit board and the touch panel 100 is accomplished.

Please referring to FIGS. 2A to 2B, if the diameter of one conductive particle 151 is larger than the width of one insulating interval 130, the conductive particle 151 may electrically connect two elements located at two sides of the insulating interval 130 and an electric short is happened. In the present embodiment, part of the insulating intervals 130 are disposed between two adjacent ones of the first pad portions 121, between two adjacent ones of the second pad portions 122, and between one of the first pad portions 121 and one of the second pad portions 122 which are adjacent for preventing from the electric short. A distance between two edges of each insulating interval 130 is larger than a diameter of each conductive particle, such as 40 micrometers.

In the above embodiment, the step S103 is preformed before the step S104. In other embodiment, the order of the step S103 and the step S104 can be exchanged. That is to say, after the pad patterns 140 are disposed at the predetermined locations of the first pad portions 121 and the second pad portions 122, the insulating intervals 130 are formed. As such, even if the coverage of one pad pattern 140 exceeds the predetermined location of one first pad portion 121 or one second pad portion 122, the pad pattern 140 can be etched to from the insulating intervals 130, such that the electric short can be prevented.

The insulating intervals 130 located between two adjacent ones of the first pad portions 121, between two adjacent ones of the second pad portions 122, and between one of the first pad portions 121 and one of the second pad portions 122 which are adjacent can be designed in various ways. For example, as shown in FIG. 2A, the insulating intervals 130 located between two adjacent first pad portions 121 and between two adjacent second pad portions 122 are substantially perpendicular the first path L1 (shown in FIG. 1) and the second path L2 (shown in FIG. 1). As such, the insulating interval 130 can prevent the uncured pad patterns 140 from spreading along the first path L1 and the second path L2.

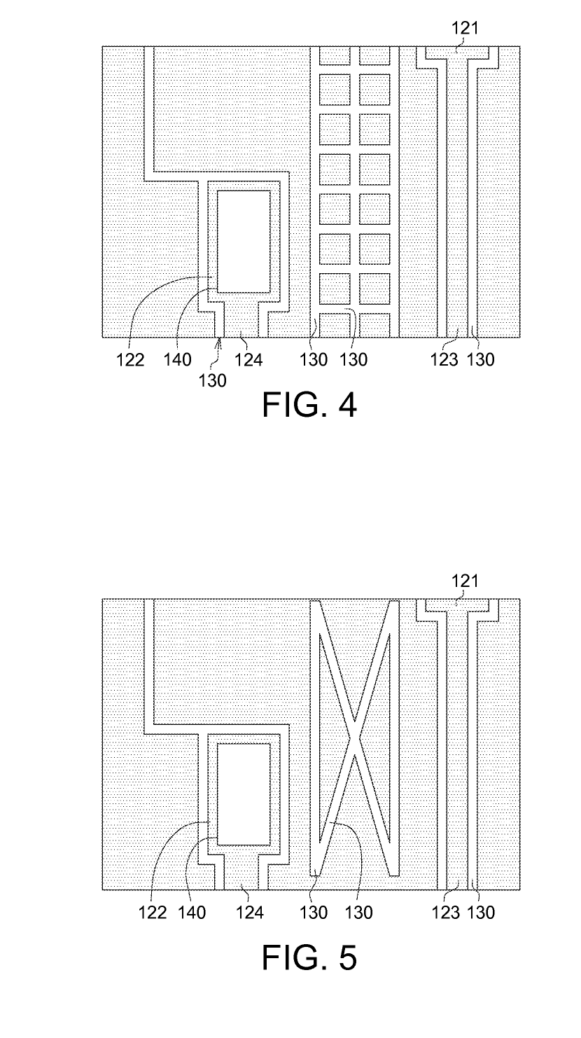

As shown in FIG. 4, it shows a plurality of insulating intervals 130 according to another embodiment. In the present embodiment, the insulating intervals 130 are arranged as a mesh. In particular, part of the insulating intervals 130 are substantially parallel with the first path L1 (sown as FIG. 1) and the second path L2 (shown as FIG. 1), and part of the insulating intervals 130 are substantially perpendicular to the first path L1 (sown as FIG. 1) and the second path L2 (shown as FIG. 1). The insulating intervals 130 parallel with the first path L1 (second path L2) and the insulating intervals 130 perpendicular to the first path L1 (second path L2) are intersected. By the insulating intervals 130 having mesh structure, the pad patterns 140 can be prevented from spreading along the directions parallel with and perpendicular to the first path L1 and the second path L2, such that the risk of electric short can be reduced.

As shown in FIG. 5, it shows the insulating intervals 130 according to another embodiment. In one embodiment, part of the insulating intervals 130 are substantially perpendicular to the first path L1 (shown in FIG. 1) and the second path (shown in FIG. 1), part of the insulating intervals 130 are substantially inclined to the first path L1 and the second path L2. The insulating intervals 130 are connected. As such, the insulating intervals 130 can prevent the pad patterns 140 form spreading along the first path L1 and the second path L2 to reduce the risk of electric short.

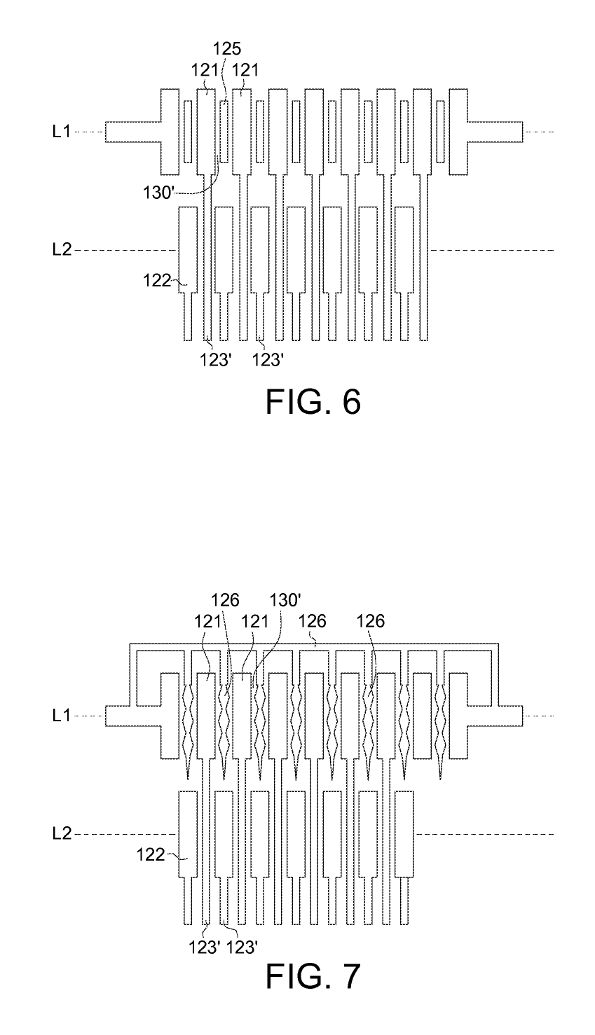

In the bonding process of the touch panel 100 and the circuit board, if the density of the conductive material layer 120 located in the upper row is different from that in the lower row, the fracture of the conductive particles 151 may be uneven to cause a connection failure. For solving this problem, please refer to FIG. 6 which shows the conductive material layer around the first pad portions 121 and the second pad portions 122 according to an embodiment. As shown in FIG. 6, the auxiliary patterns 125 are disposed between two adjacent first pad portions 121. The auxiliary patterns 125 may be formed by the step of etching conductive material layer 120 to form the insulating intervals 130′. The first pad portions 121 and the auxiliary patterns 125 are insulated with each other by the insulating intervals 130′. The insulating intervals 130′ may be the insulating intervals 130 described above. The signal transmitting line 123′ is disposed between two adjacent second pad portions 122. As such, the density of the conductive material at the first path L1 is similar to that at the second path L2. Therefore, the force applied on the touch panel 100 and the circuit board can be easily controlled and the yield rate of the conduction can be improved. It is noted that a conductive material can be disposed outside the first pad portions 121 and the second pad portions 122 for reducing the area etched by the laser to improve the manufacturing efficiency. However, the invention is not limited thereto.

Moreover, the electro static discharge (ESD) is also an important issue. Please referring to FIG. 7, it shows the conductive material layer around the first pad portions 121 and the second pad portions 122 according to another embodiment. In this embodiment, each auxiliary pattern 126 disposed between two adjacent first pad portions 121 can be connected to a ground. The auxiliary patterns 126 can be formed by the step of etching the conductive material layer 120 to from the insulating intervals 130′. As such, the auxiliary patterns 126 can absorb the discharged static electricity caused by surge current. On the other hand, the density of the conductive material at the first path L1 is similar to that at the second path L2 and the yield rate of the conduction can be improved. Further, in other embodiment, each auxiliary pattern 126 disposed between two adjacent first pad portions 121 can be connected to a ground to prevent from any interference between the first pad portions 121.

Moreover, the auxiliary patterns 126 can have acute angle shaped protrusions. As shown in FIG. 7, the end of each auxiliary pattern 126 is needle shaped and the body of each auxiliary pattern 126 is connected rhombus shaped. As such, each auxiliary pattern 126 has a plurality of acute angle protrusions to absorb the discharged static electricity, and the antistatic ability can be improved greatly.

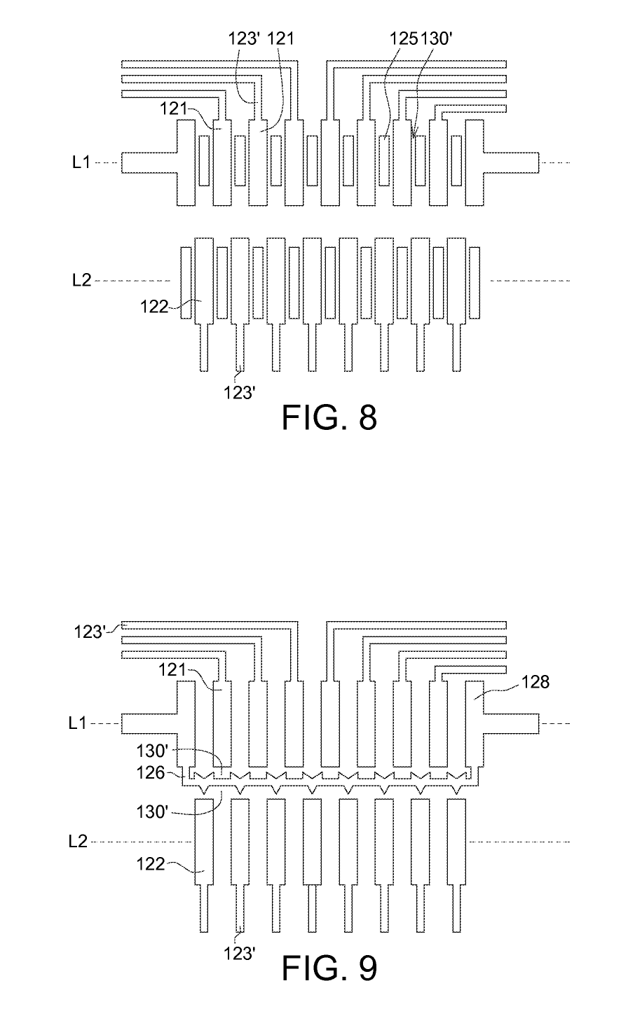

In one embodiment, the density of the conductive material can be changed by changing the location of the signal transmitting line 123′. Please referring to FIG. 8, it shows the conductive material layer around the first pad portions 121 and the second pad portions 122 according to another embodiment. Part of the signal transmitting line 123′ connected to the first pad portions 121 extend toward a direction opposite to the second pad portions 122, another part of the signal transmitting line 123′ connected to the second pad portions 122 extend toward a direction opposite to the first pad portions 121. That is to say, the signal transmitting lines 123′ are not located between two adjacent ones of the first pad portions 121 and between two adjacent ones of the second pad portions 122. Each auxiliary pattern 125 is disposed between two adjacent first pad portions 121 or between two adjacent second pad portions 122. The auxiliary patterns 125, the first pad portions 121 and the second pad portions 122 are electrically insulated with each other by the insulating intervals 130′. As such, the density of the conductive material at the first path L1 is substantially identical to that at the second path L2. The force applied on the flexible circuit board can be easily controlled and the yield rate of the conduction can be improved.

In another embodiment, the location of the auxiliary pattern 126 can be designed according to various requirements. Please referring to FIG. 9, it shows the conductive material layer around the first pad portions 121 and the second pad portions 122 according to another embodiment. The auxiliary pattern 126 can be disposed between all of the first pad portions 121 and all of the second pad portions 122. The auxiliary pattern 126 may have a plurality of acute angle protrusions. The auxiliary pattern 126 is connected to a ground via the aligning pads 128 disposed at two sides of the first pad portions 121. The first pad portions 121 and the auxiliary pattern 126 are insulated with each other by the insulating intervals 130′. The second pad portions 122 and the auxiliary pattern 126 are insulated by the insulating intervals 130′. As such, the auxiliary pattern 126 can absorb the discharged static electricity caused by surge current of the first pad portions 121 and the second pad portions 122, and the antistatic ability can be improved greatly.

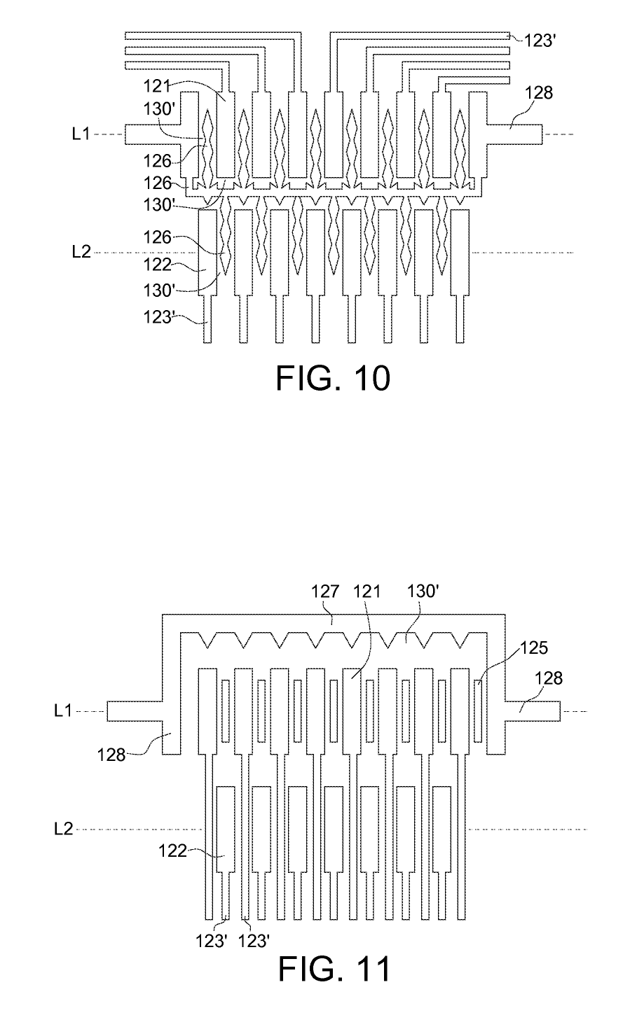

In another embodiment, the location of the auxiliary pattern 126 can be designed according to various requirements. Please referring to FIG. 10, FIG. 10 shows the conductive material layer around the first pad portions 121 and the second pad portions 122 according to another embodiment. The auxiliary pattern 126 is disposed between two adjacent first pad portions 121, between two adjacent pad portions 122 and between all of the first pad portions 121 and all of the second pad portions 122. The auxiliary pattern 126 is connected to a ground via the aligning pads 128 disposed at two sides of the first pad portions 121. The first pad portions 121 and the auxiliary pattern 126 are insulated by the insulating intervals 130′. The second pad portions 122 and the auxiliary pattern 126 are insulated by the insulating intervals 130′. As such, each first pad portion 121 or each second pad portion 122 is surrounded by the auxiliary pattern 126. The auxiliary patterns 126 can absorb the discharged static electricity caused by surge current of the first pad portions 121 and the second pad portions 122, and the antistatic ability can be improved greatly. On the other hand, the density of the patterns at the first path L1 is substantially identical to that at the second path L2, and the yield rate of the conduction can be improved.

Please referring to FIG. 11, it shows the conductive material layer around the first pad portions 121 and the second pad portions 122 according to another embodiment. A ground pattern 127 is disposed at outside of the first pad portions 121. In this embodiment, two ends of the ground pattern 127 are connected to the aligning pads 128 disposed at two sides of the first pad portions 121 respectively, such that the ground pattern 127 is connected to a ground. A plurality of acute angle protrusions of the ground pattern 127 are extended toward the first pad portions 121. The first pad portions 121 and the ground pattern 127 are insulated by the insulated intervals 130′. As such, the ground pattern 127 can absorb the discharged static electricity caused by surge current of the first pad portions 121 and the antistatic ability can be improved greatly.

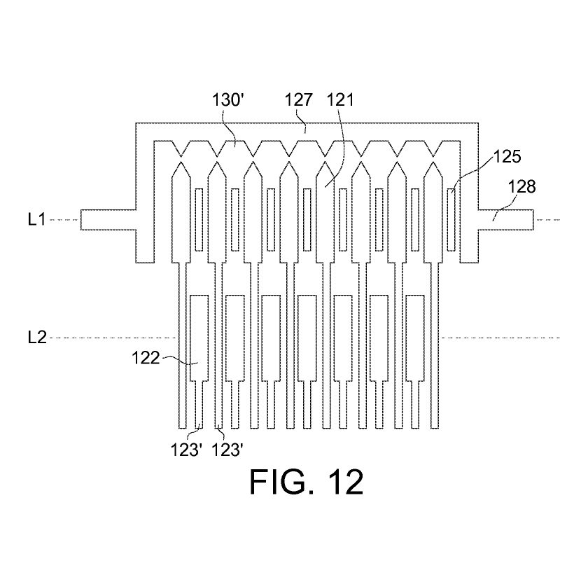

In another embodiment, the shape of the first pad portions 121 can be partially similar to the shape of the ground pattern 127. Please referring to FIG. 12, it shows the conductive material layer around the first pad portions 121 and the second pad portions 122 according to another embodiment. Each first pad portion 121 can have an acute angle shaped end. The acute angle end of the first pad portion 121 can extend toward one acute angle protrusion of the ground pattern 127. The first pad portions 121 and the ground pattern 127 are insulated by the insulating intervals 130′. As such, the ground pattern 127 can easily absorb the discharged static electricity caused by surge current of the first pad portions 121, and the antistatic ability can be improved greatly.

Moreover, according to the method of this disclosure, the conductive patterns, the first pad portions 121, the second pad portions 122, the signal transmitting lines 123′, the auxiliary patterns 125, 126 or the ground pattern 127 can be simultaneously formed by the step of etching the conductive material layer 120 to form the insulating intervals 130. Those elements can be easily formed without large manufacturing cost.

Further, the insulating intervals 130 can prevent the pad patterns 140 from spreading to avoid electric short or electric leakage. The insulating intervals 130 can prevent electric short caused by the conductive particles 151 connecting the first pad portions 121, the second pad portions 122, or the signal transmitting lines 123′.

Moreover, the density of the patterns at the first path L1 can be substantially identical to that at the second path L2 by disposing the auxiliary patterns 125, 126. Therefore, the force applied on the touch panel 100 and the circuit board can be easily controlled and the yield rate of the conduction can be improved.

Further, the ground pattern 127 can absorb the discharged static electricity caused by surge current, and the antistatic ability can be improved greatly. Similarly, the auxiliary patterns 125, 126 can be connected to ground for improving the antistatic ability.

Preferred embodiments are disclosed below for elaborating the invention. An implanting region is fully disposed, such that the body effect can be improved, and it is no needed to add any additional mask and any addition cost. However, the following embodiments are for the purpose of elaboration only, not for limiting the scope of protection of the invention. Besides, secondary elements are omitted in the following embodiments to highlight the technical features of the invention.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch panel, comprising:
a substrate;
a plurality of conductive patterns disposed on the substrate;
a plurality of signal transmitting lines disposed on the substrate;
a plurality of first pad portions electronically connected to part of the conductive patterns via part of the signal transmitting lines, wherein the first pad portions are separately arranged along a first path;
a plurality of second pad portions electronically connected to another part of the conductive patterns via another part of the signal transmitting lines, wherein the second pad portions are insulated from the first pad portions, the second pad portions are separately arranged along a second path which is not overlapped with the first path, and each second pad portion is disposed between two adjacent ones of the first pad portions; and
at least one auxiliary pattern disposed between two adjacent ones of the first pad portions, between two adjacent ones of the second pad portions, or between one of the first pad portions and one of the second pad portions which are adjacent, wherein the at lease one auxiliary pattern is insulated from the conductive patterns, the signal transmitting lines, the first pad portions and the second pad portions;
wherein a plurality of insulating intervals are located between two adjacent ones of the first pad portions, between two adjacent ones of the second pad portions, and between one of the first pad portions and one of the second pad portions which are adjacent, respectively.

2. The touch panel according to claim 1, wherein some of the insulating intervals are located at edges of the first pad portions and the second pad portions.

3. The touch panel according to claim 2, wherein the insulating intervals disposed between two adjacent ones of the first pad portions are strip shaped, the number of the insulating intervals disposed between two adjacent first pad portions is plurality, the insulating intervals disposed between two adjacent second pad portions is strip shaped, and the number of the insulating intervals disposed between two adjacent ones of the second pad portions is plurality.

4. The touch panel according to claim 3, wherein part of the insulating intervals are intersected.

5. The touch panel according to claim 1, further comprising:
a plurality of pad patterns, disposed on the first pad portions and the second pad portions, wherein the insulating intervals penetrate the pad patterns, and a resistivity of each pad pattern is less than that of each first pad portion and that of each second pad portion.

6. The touch panel according to claim 1, further comprising:
a plurality of pad patterns disposed on the first pad portions and the second pad portions, wherein each pad pattern is smaller than each first pad portion and each second pad portion, wherein a resistivity of each pad pattern is less than that of each first pad portion and that of each second pad portion.

7. The touch panel according to claim 1, wherein the at least one auxiliary pattern is disposed between two adjacent ones of the first pad portions or between two adjacent ones of the second pad portions, and the at least one auxiliary pattern is connected to a ground.

8. The touch panel according to claim 7, wherein an edge of the auxiliary pattern connected to the ground has a plurality of acute angle shaped protrusions.

9. The touch panel according to claim 1, wherein the at least one auxiliary pattern is disposed between one of the first pad portions and one of the second pad portions which are adjacent, and the at least one auxiliary pattern is connected to a ground.

10. The touch panel according to claim 1, further comprising:
a ground pattern, disposed at an outside of the first pad portions, wherein the ground pattern has a plurality of acute angle shaped protrusions extended toward the first pad portions, and each first pad portion has an acute angel shaped end extended toward one of the acute angle shaped protrusions.

11. The touch panel according to claim 1, wherein part of the signal transmitting lines connected to the first pad portions and another part of the signal transmitting lines connected to the second pad portions are extended toward two opposite directions.

12. The touch panel according to claim 1, wherein part of the signal transmitting lines connected to the first pad portions and another part of the signal transmitting lines connected to the second pad portions are extended toward the same direction.

13. The touch panel according to claim 1, wherein a distance between two edges of each insulating interval is larger than 40 micrometers.

14. The touch panel according to claim 1, further comprising an anisotropic conductive film covering the first pad portions and the second pad portions, wherein the anisotropic conductive film includes a plurality of conductive particles, and the distance between two edges of each insulating interval is larger than a diameter of each conductive particle.

15. The touch panel according to claim 1, wherein a bottom surface of each insulating interval has a plurality of dents.

16. A touch panel, comprising:
a substrate;
a plurality of conductive patterns disposed on the substrate;
a light shading layer disposed on the substrate;
a plurality of signal transmitting lines disposed on the light shading layer;
a plurality of first pad portions disposed on the light shading layer, and connected to part of the conductive patterns via part of the signal transmitting lines, wherein the first pad portions are separately arranged along a first path;
a plurality of second pad portions disposed on the light shading layer, and connected to another part of the conductive patterns via another part of the signal transmitting lines, wherein the second pad portions are insulated from the first pad portions, the second pad portions are separately arranged along a second path which is not overlapped with the first path, and each second pad portion is disposed between two adjacent ones of the first pad portions; and
a plurality of aligning pads disposed on the light shading layer for aligning with a circuit board;
wherein a plurality of insulating intervals are located between two adjacent ones of the first pad portions, between two adjacent ones of the second pad portions, and between one of the first pad portions and one of the second pad portions which are adjacent, respectively.

17. The touch panel according to claim 16, wherein a bottom surface of each insulating interval has a plurality of dents.

18. The touch panel according to claim 17, wherein each of the aligning pads is connected to a ground.

19. A manufacturing method of a touch panel, comprising:
providing a substrate;
forming a conductive material layer on the substrate; and
etching the conductive material layer to form a plurality of insulating intervals, a plurality of conductive patterns, a plurality of first pad portions, a plurality of second pad portions and at least one auxiliary pattern, wherein the first pad portions are disposed along a first path, the second pad portions are disposed along a second path, each second pad portion is disposed between two adjacent ones of the first pad portions, the number of the insulating intervals disposed between every two adjacent ones of the first pad portions and the number of the insulating intervals between every two adjacent ones of the second pad portions are equal to or larger than two, the at least one auxiliary pattern is disposed between two adjacent ones of the first pad portions, between two adjacent ones of the second pad portions, or between one of the first pad portions and one of the second pad portions which are adjacent, and the at least one auxiliary pattern is insulated from the conductive patterns, the first pad portions and the second pad portions.

20. The manufacturing method of the touch panel according to claim 19, wherein the conductive material layer are etched by a laser.
